(19) United States
(12) Patent Application Publication
(10) Pub. No.: US 2025/0007635 A1
(43) Pub. Date: Jan. 2, 2025

(54) METHOD, APPARATUS AND SYSTEM FOR MULTI-BAND ANALOG RADIO SIGNAL PROCESSING FOR TERMINATION TO A NETWORK-CONNECTED DEVICE

(71) Applicant: Vonage Business Inc., Holmdel, NJ (US)

(72) Inventors: Atique Ahmed KHAN, London (GB); Rosaline Sarah SUPRIYA, Bordentown, NJ (US); Michael John SINGLETON, Surrey (GB)

(21) Appl. No.: 18/217,254

(22) Filed: Jun. 30, 2023

(51) Int. Cl. H04H 60/87; H04B 1/00; H04H 60/37

(52) U.S. Cl. CPC H04H 60/87; H04B 1/005; H04H 60/37

(57) ABSTRACT

Methods, apparatuses and system for multiband radio signal processing for providing radio signals to a network connected device include receiving multiband radio signals, tuning the multiband radio signal to a radio frequency band based on a received request from a network-connected device for the radio frequency band, and communicating data associated with the requested radio frequency band to the requesting network-connected device over the network using an application programming interface. At the network-connected device, the data associated with the requested radio frequency band can be received and presented on an output device of the network-connected device using an installed application.

### BACKGROUND

### Field

Embodiments of the present invention generally relate to the capture and processing of analog and digital radio signals, and more specifically to a method, apparatus and system for the processing of analog and digital radio signals for use by network-connected devices.

### Description of the Related Art

Currently for internet connected devices, such as mobile phones, to be able to receive radio signals, the device must contain at least one radio signal antenna and a tuner chip, such as an FM chip and be in the vicinity of the reach of the transmission of the radio signal. Providing the capability for an internet connected device to receive local radio signals raises the cost of such devices and complicates the circuitry of the device at least because of the need to include additional hardware in the device and because a manufacturer of the device would need to work out the details on how to direct the radio signals, such as an FM radio station, to the speakers of the internet connected devices when necessary. Even further, currently there are no easy ways for internet connected devices to receive radio signals when not in the vicinity of a transmitter.

Therefore, there is a need for enabling an internet connected device to receive radio signals irrespective of a location of the transmitter.

### SUMMARY

Methods, apparatuses and systems are provided for processing multiband, analog and digital radio signals to provide the multiband radio signal to a network-connected device, such as an internet connected device, irrespective of a location of a transmitter.

In some embodiments, a method for multiband radio signal processing for providing radio signals to a network connected device includes receiving multiband radio signals, tuning the multiband radio signal to a radio frequency band based on a received request from a network-connected device for the radio frequency band, and communicating data associated with the requested radio frequency band to the requesting network-connected device over the network using an application programming interface.

In some embodiments the method can further include converting the requested radio frequency band to a digital data signal before communicating the data associated with the selected radio frequency band to the requesting network-connected device.

In some embodiments the method can further include monitoring the requested radio frequency band to identify sound recordings in the requested radio frequency band for which royalties need to be collected and distributed.

In some embodiments, the method can further include providing a web application for enabling communication with the application programming interface.

In some embodiments, the method can further include presenting data associated with the requested radio frequency band on the requesting network-connected device using an application installed on the network-connected device.

In some embodiments, an apparatus for multiband radio signal processing for providing radio signals to a network connected device includes at least one processor and at least one memory for storing programs and instructions. In such embodiments, when the programs and instructions are executed by the at least one processor, the apparatus is caused to perform operations including receiving multiband radio signals, tuning the multiband radio signal to a radio frequency band based on a received request from a network-connected device for the radio frequency band, and communicating data associated with the requested radio frequency band to the requesting network-connected device over the network using an application programming interface.

In some embodiments, a system for multiband radio signal processing for providing radio signals to a network connected device includes an antenna configured to receive radio signals, a tuning chip configured to tune radio signals, a software defined radio module configured to convert radio signals to a discrete digital radio signals, an application program interface module configured to communicate with a software application of a remote network-connected device, and an apparatus including at least one processor and at least one memory for storing programs and instructions. In such embodiments, when the programs and instructions are executed by the at least one processor, the system is caused to perform operations including receiving multiband radio signals at the antenna, using the tuning chip, tuning the multiband radio signal to a radio frequency band based on a received request from a user using the software application of the network-connected device, and communicating data associated with the requested radio frequency band to the requesting network-connected device over the network using the application programming interface module.

Other and further embodiments of the present invention are described below.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1A depicts a block diagram of a radio signal access system in accordance with an embodiment of the present principles and invention.

FIG. 1B depicts a representation of the different environments and interconnecting networks that comprise an embodiment of the present principles and invention.

FIG. 2 depicts a graphical representation of exemplary radio frequencies that can be communicated via a radio signal access system in accordance an embodiment of the present principles and invention.

FIG. 3 depicts a flow diagram of a method for multiband radio signal processing for providing radio signals to a network connected device in accordance with an embodiment of the present principles and invention.

FIG. 4 depicts an embodiment of a computer system in which at least a portion of a radio signal access system can be implemented in accordance with an embodiment of the present principles and invention.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present invention generally relate to methods, apparatuses and systems for processing multiband radio signals to provide radio signals to a network-connected device, such as an internet connected device, without the need for the network-connected device to include a radio antenna and/or a tuning chip and/or without regard for the location of the transmitter with respect to the location of the receiving (network-connected) device.

While the concepts of the present principles are susceptible to various modifications and alternative forms, specific embodiments thereof are shown by way of example in the drawings and are described in detail below. It should be understood that there is no intent to limit the concepts of the present principles to the particular forms disclosed. On the contrary, the intent is to cover all modifications, equivalents, and alternatives consistent with the present principles and the appended claims. For example, although embodiments of the present principles are described herein with respect to specific radio signals, such as FM radio signals and satellite signals being provided to specific internet connected devices, such as a mobile phone, via the Internet, embodiments of the present principles can be applied for providing substantially any radio signals to substantially any network connected devices via substantially any network.

Embodiments of the present principles include methods, apparatuses and systems for capturing, extracting, converting and re-transmitting messages from analog and digital radio signals to multiple Internet connected devices so as to expand the user base of locally transmitted radio signals to the rest of the world. Further, embodiments of the present principles include methods, apparatuses and systems for integrating analog and digital components with Application Programming Interfaces (APIs) to transform and optimize real-time radio services (such as health monitoring data), and telemetry devices (such as weather stations, mobile data terminals and RFID readers) for Internet data transfer to users across vast geographical regions.

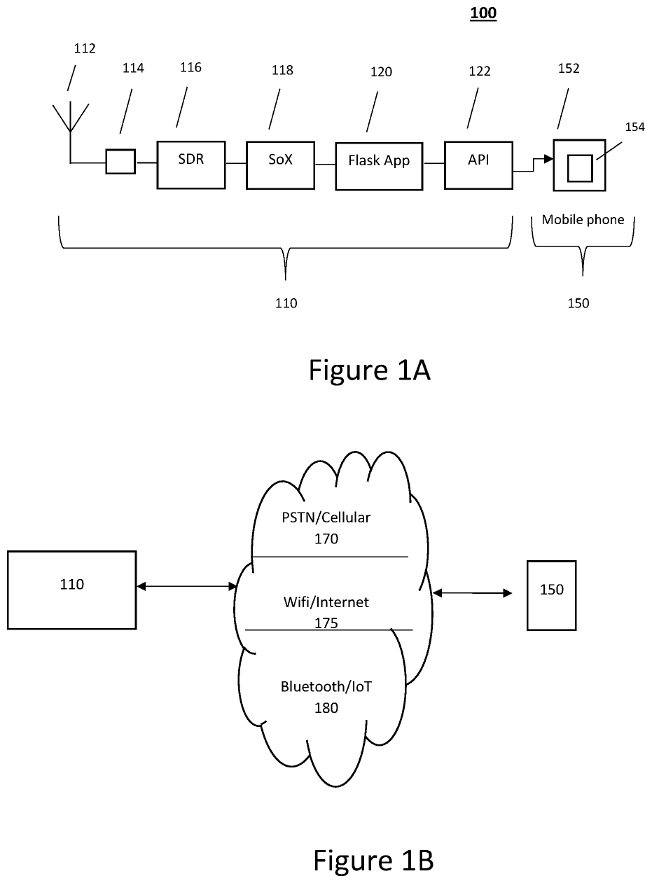

FIG. 1A depicts a block diagram detailing the functional architecture of a radio signal access system 100 in accordance with an embodiment of the present principles and invention. The radio signal access system 100 of FIG. 1A illustratively includes a remote component environment 110 and a local component environment 150. The remote component environment 110 of the radio signal access system 100 of FIG. 1A illustratively includes a radio antenna 112, a radio frequency chip 114, a software defined radio (SDR) module 116, an optional data transformation library module 118, an optional web interface module 120, and an application programming interface (API) module 122. In the embodiment of FIG. 1A, the optional data transformation library module 118 is a Sound exchange library module, the web interface module 120 is a web application such as, but not limited to Flask and the local component environment 150 includes a network connected device 152 (illustratively a mobile phone).

In the remote component environment 110 of the radio signal access system 100, the radio antenna 112 and radio frequency chip 114, together, receive multiband, radio signals. The multiband radio signals are communicated to the SDR module 116. At the SDR module 116, the received multiband, radio signals are converted to a discrete digital radio signal. For example, in some embodiments of the present principles, the SDR module 116 uses an RF tuner to down convert a frequency band of interest to an intermediate frequency (IF) within the range of an analog to digital converter (not shown) included in the SDR module 116. In some embodiments in a radio signal access system 100 of the present principles, a frequency band of interest is selected by the SDR module 116 based on a frequency band that was selected (described in greater detail below) using a device of a local component environment 150, such as the mobile phone 152.

In the embodiment of the radio signal access system 100 of FIG. 1A, the digital frequency band from the SDR module 116 is communicated to the optional data transformation module 118. In one particular embodiment of the data transformation module being a SoX library module, it can identify sound recordings for which royalties need to be collected and distributed. Although the embodiment of the radio signal access system 100 of FIG. 1A illustratively includes an optional SoX library module 118, in alternate embodiments of a radio signal access system of the present principles, a SoX library module is not included and sound recording for which royalties need to be collected and distributed can be identified by other means.

As depicted in the radio signal access system 100 FIG. 1A, the digital frequency band converted and selected by the SDR module 116 can be communicated to the optional web interface module 120. In the embodiment of the radio signal access system 100 of FIG. 1A, the web interface module 120 provides a web framework and tools to build a web application, for example, in which to provide communications with the API module 122. In one embodiment, the interface is created by the web application. Although the embodiment of the radio signal access system 100 of FIG. 1A illustratively includes an optional web interface module 120, alternate embodiments of a radio signal access system 100 do not need to include an optional interface module and can communicate with local devices via other means. For example, in some embodiments of a radio signal access system of the present invention, an API in the remote component environment 110 can communicate with a network-connected device in the local component environment 150, such as a mobile device, via a private network interconnecting the API of the remote component environment 110 with the network-connected device in the local component environment 150. In one or more embodiments described herein, a suitable API can be either the Messages API or the Voice API both available in the Vonage Communications Platform (VCP) offered by Vonage Business Inc. Depending on the type of data being transferred between the two environments, an appropriate API can be selected and used to complete data transmission. For example, Messages API can be used to record/transform data and send it to appropriate message channels and Voice API can stream data to the PSTN, Websocket or SIP calls.

FIG. 1B depicts a representation of how the radio signal access system 100 communicates with the mobile device 152. For example, the API module 122 in the remote component environment 110 can communicate with the mobile device 152 in the local component environment 150 via an application 154 installed in the mobile device 152. Connection between the remote component environment 110 and the local component environment 150 can be by one or more of known networks or data connection methodologies known to those skilled in the art including but not limited to Internet protocol, a PSTN/cellular protocol, a WiFi connection to the mobile device 152 where a WiFi router is then connected to a data network such as the Internet. In each instance, the application 154 is capable of communicating with the API 122.

As depicted earlier and described above, the API module 122 can communicate with the mobile device 152 via application 154. A user (not shown) of the mobile device 152 can use the application 154 to select a desired radio frequency to be presented on the mobile device 152. Upon selection of a desired radio frequency using the application 154 on the mobile device 152, a signal is communicated to the API module 122 which communicates information regarding the desired frequency to the SDR module 116. As previously described above, the SDR module 116 selects the desired frequency band and the API module 122 communicates the desired frequency band to the mobile device 152 via the application 154.

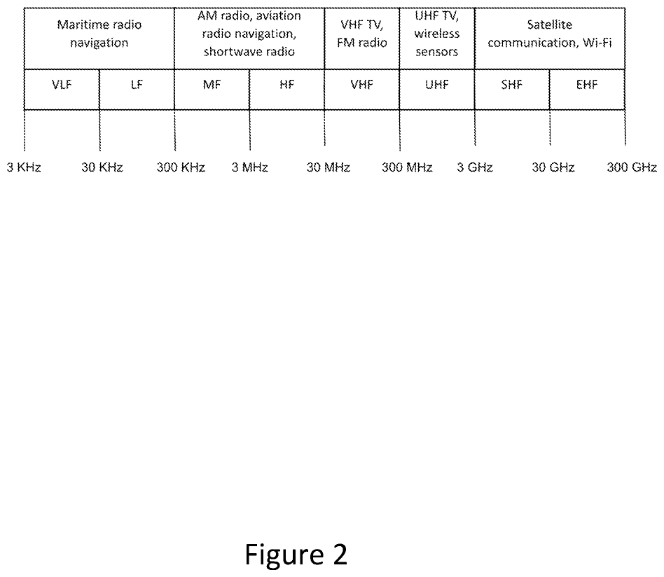

Although in some embodiments, aspects of the present principles are being described with reference to AM/FM radio signals, it should be noted that, in accordance with the present principles, the frequency band spectrum to which embodiments of the present principles are applicable encompasses wireless frequencies and is the frequency range is only limited by the capacity of tuning chip 114 and data transformation 118 and can include ANT Radio Service (to view fitness and health monitoring data in realtime) and IoT devices (Weather station, MDTs and RFID Readers). The frequency range of embodiments of the present principles is described in greater detail below with reference to FIG. 2.

With specific attention to the functionality of each module, we refer back to the radio signal access system 100 of FIG. 1A. The capturing of radio signals starts with a radio antenna 112 which can be selected based on a targeted frequency. For example, an outdoor whip antenna measuring 71.5 cm can be used for the reception of frequencies from 25 to 2000 MHz. Note that the position and type of antenna will be crucial to receive signals at the desired frequency spectrum. Frequency tuning can be accomplished using the radio frequency chip 114 which in some embodiments encompasses an Amplifier/Filter (not shown) and an Analog to Digital Converter (ADC) (not shown). As the signals are captured at the tuned frequency, in the embodiment of FIG. 1A, the signals are converted into raw digital format and passed to the Software Defined Radio (SDR) module 116 which acts as the digital backend for processing, command, control and conversion of signals.

In some embodiments, the SDR module 116 can be a stripped-down driver, a command-line tool or a graphical user interface (GUI). The output from the SDR module 116 is a digitally converted audio stream. Although this audio stream is ready to be utilized, it can be optionally converted into other sound formats using the SoX library module 118. A purpose of the SoX library module 118 can include to choose an efficient audio encoding format that is easy to transfer with compression and has minimum loss of information. Once the suitable encoded audio stream is established, it is made accessible to Internet connected devices using the web interface module 120. In some embodiments, the web interface module 120 has a published URL, an IP address or websocket address that acts as an endpoint or a server to exchange data between the locally generated audio stream and Internet connected devices. Protocols, including but not limited to HTTP, Websocket, TCP/IP and UDP can be implemented in such embodiments.

For interfacing with mobile devices and other messaging formats, like messaging and WebRTC, in the embodiment of FIG. 1A an API module 122 is introduced between the web interface module 120 and the Internet connected device 150. In some embodiments, the API modules of the present principles can be commercially available and can be used to convert audio streams to acceptable format for applications, such as application 154, installed on Internet connected device 150 (mobile phone). Alternatively, the application 154 can be used to transmit commands, such as change the channel frequency, which can then be received by the API module 122 and communicated to the web interface module 120. The command is then sent to the SDR 116 which then tunes the desired frequency using the RF tuning chip 114 and starts capturing radio signals on the newly selected frequency.

FIG. 2 depicts a graphical representation of exemplary radio frequencies that can be communicated via a radio signal access system of the present principles. The flexibility and programmability of the SDR module 116 enables a system of the present principles to capture different frequency ranges provided that the correct type of antenna 112 is being implemented. Assuming that the system has already provisioned antenna requirements, the system is able to work with at least the following bands in the radio spectrum:
Very Low Frequency (VLF) and Low Frequency (LF) range between 3 kHz and 300 kHz used for navigation signals, time signals and geophysical research
Medium Frequency (MF) and High Frequency (HF) range between 300 KHz and 30 MHz used for AM radio broadcasting, aviation communications, maritime communications and amateur radio
Very High Frequency (VHF) range between 30 MHz and 300 MHz used for FM radio broadcasting, television broadcasting, air traffic control and public safety communications
Ultra High Frequency (UHF) range between 300 MHz and 3 GHz used for television broadcasting, mobile communications, satellite communications and wireless LANs
Super High Frequency (SHF) and Extremely High Frequency (EHF) range between 3 GHz and 300 GHz used for satellite communications, bluetooth devices and navigation systems.

For example, in the embodiment of the radio signal access system 100 of FIG. 1A, a user can select an AM/FM frequency band using the application 154 installed in the mobile device 152 for listening to a terrestrial AM/FM radio station. As described above, the frequency band selection made using the application 154 on the mobile device 152 can be communicated to the API module 122 in the remote component environment 110 of the radio signal access system 100. Information regarding the selected frequency band can be communicated to the SDR 116 which tunes received multiband radio signals to the selected frequency band. The selected frequency band can then be communicated to the mobile device 152 using the API module 122 and the application 154 installed on the mobile device 152. The terrestrial AM/FM radio station can then be played/presented via output devices of the mobile device 152, such as speakers (not shown) or a video display (not shown) of the mobile device 152.

Similarly, a user of the mobile device 152 can select to receive data being broadcast by a satellite on a specific frequency band. For example, in the radio signal access system 100 of FIG. 1A, a user of the mobile device 152 can select the desired frequency band at which the satellite is broadcasting data using the application 154 installed on the mobile device. The frequency band selection made using the application 154 on the mobile device 152 can be communicated to the API module 122 in the remote component environment 110 of the radio signal access system 100. Information regarding the selected frequency band can be communicated to the SDR 116 which tunes received multiband radio signals to the selected frequency band. The selected frequency band can then be communicated to the mobile device 152 using the API module 122 and the application 154 on the mobile device 152. The satellite data being communicated via the selected radio frequency band can then be played/presented via output devices of the mobile device 152, such as speakers (not shown) of the mobile device or a video display (not shown) of the mobile device 152. For example, in one specific embodiment, the radio access system of the present principles can access data broadcast by the FUNcube amateur satellite that broadcasts data on a frequency of 145.93 MHz.

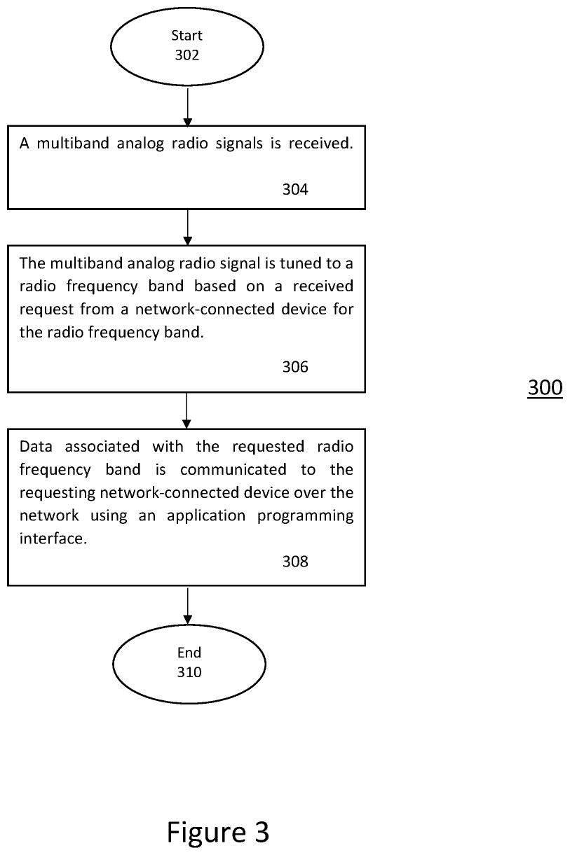

FIG. 3 depicts a flow diagram of a method 300 for multiband radio signal processing for providing radio signals to a network connected device in accordance with an embodiment of the present principles. The method 300 can begin at 302 and proceeds to 304 during which multiband radio signals are received. The method 300 can proceed to 306. At 306, the multiband radio signal is tuned to a radio frequency band based on a received request from a network-connected device for the radio frequency band. The method 300 can proceed to 308.

At 308, data associated with the requested radio frequency band is communicated to the requesting network-connected device over the network using an application programming interface. The method can end at 310.

In some embodiments of the present principles and invention, the method 300 can further include converting the requested radio frequency band to a digital data signal before communicating the data associated with the selected radio frequency band to the requesting network-connected device.

In some embodiments of the present principles and invention, the method 300 can further include monitoring the requested radio frequency band to identify sound recordings in the requested radio frequency band for which royalties need to be collected and distributed.

In some embodiments of the present principles and invention, the method 300 can further include providing a web application for enabling communication with the application programming interface.

In some embodiments of the present principles and invention, the method 300 can further include presenting data associated with the requested radio frequency band on the requesting network-connected device using an application installed on the network-connected device.

In some embodiments of the present principles and invention, the method 300 can further include presenting data associated with the radio services that transmits telemetric data related to fitness and health monitoring, weather stations, Mobile Data Terminals (MDTs) and RFID readers.

Embodiments of the present principles enable a reception of radio signals by, for example a mobile receiving device, irrespective of a location of a transmitter. For instance, in one example in a remote town, Police and Fire services can operate using a radio frequency of 86.30 MHz within a specific terrestrial radius. In such instances, the range of the radio signal is dependent upon a type of broadcasting antenna being used, the output power of the transmitter, and atmospheric conditions. If a member of the Police and Fire services desires to receive the broadcast when not within the range of the antenna and transmitter combination, a system of the present principles can link an SDR to a communication API, as described above, and can convert the previous local-only transmitted radio frequency signal of 86.30 MHZ obtainable all over the world.

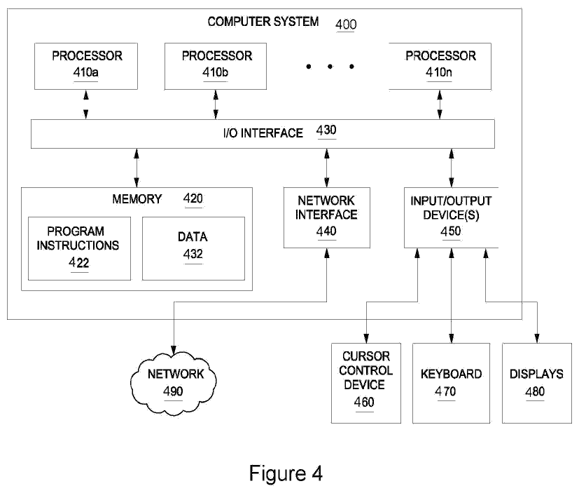

FIG. 4 depicts an embodiment of a computer system 400 in which at least a portion of a radio signal access system, such as the radio signal access system 100 of FIG. 1A can be implemented. Various embodiments of a method, apparatus and system for multiband radio signal processing for providing radio signals to a network connected device, as described herein, can be executed on one or more computer systems, which may interact with various other devices. One such computer system is computer system 400 illustrated by FIG. 4, which may in various embodiments implement any of the elements or functionality illustrated in FIGS. 1-3. In various embodiments, computer system 400 can be configured to implement methods described above. The computer system 400 can be used to implement any other system, device, element, functionality or method of the above-described embodiments. In the illustrated embodiments, the system 400 can be configured to implement method 300, as processor-executable executable program instructions 422 (e.g., program instructions executable by processor(s) 410) in various embodiments.

In the illustrated embodiment, computer system 400 includes one or more processors 410 coupled to a system memory 420 via an input/output (I/O) interface 430. Computer system 400 further includes a network interface 440 coupled to I/O interface 430, and one or more input/output devices 450, such as cursor control device 460, keyboard 470, and display(s) 480. In various embodiments, any of components may be utilized by the system to receive user input described above. In various embodiments, a user interface (e.g., user interface 430) may be generated and displayed on display 480. In some cases, it is contemplated that embodiments may be implemented using a single instance of computer system 400, while in other embodiments multiple such systems, or multiple nodes making up computer system 400, may be configured to host different portions or instances of various embodiments. For example, in one embodiment some elements may be implemented via one or more nodes of computer system 400 that are distinct from those nodes implementing other elements. In another example, multiple nodes may implement computer system 400 in a distributed manner.

In different embodiments, computer system 400 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, computer system 400 may be a uniprocessor system including one processor 410, or a multiprocessor system including several processors 410 (e.g., two, four, eight, or another suitable number). Processors 410 may be any suitable processor capable of executing instructions. For example, in various embodiments processors 410 may be general-purpose or embedded processors implementing any of a variety of instruction set architectures (ISAs), such as the x96, PowerPC, SPARC, or MIPS ISAs, or any other suitable ISA. In multiprocessor systems, each of processors 410 may commonly, but not necessarily, implement the same ISA.

System memory 420 may be configured to store program instructions 422 and/or data 432 accessible by processor 410. In various embodiments, system memory 420 may be implemented using any suitable memory technology, such as static random access memory (SRAM), synchronous dynamic RAM (SDRAM), nonvolatile/flash-type memory, persistent storage (magnetic or solid state), or any other type of memory. In the illustrated embodiment, program instructions and data implementing any of the elements of the embodiments described above may be stored within system memory 420. In other embodiments, program instructions and/or data may be received, sent or stored upon different types of computer-accessible media or on similar media separate from system memory 420 or computer system 400.

In one embodiment, I/O interface 430 may be configured to coordinate I/O traffic between processor 410, system memory 420, and any peripheral devices in the system, including network interface 440 or other peripheral interfaces, such as input/output devices 450, In some embodiments, I/O interface 430 may perform any necessary protocol, timing or other data transformations to convert data signals from one component (e.g., system memory 420) into a format suitable for use by another component (e.g., processor 410). In some embodiments, I/O interface 430 may include support for devices attached through various types of peripheral buses, such as a variant of the Peripheral Component Interconnect (PCI) bus standard or the Universal Serial Bus (USB) standard, for example. In some embodiments, the function of I/O interface 430 may be split into two or more separate components, such as a north bridge and a south bridge, for example. Also, in some embodiments some or all of the functionality of I/O interface 430, such as an interface to system memory 420, may be incorporated directly into processor 410.

Network interface 440 may be configured to allow data to be exchanged between computer system 400 and other devices attached to a network (e.g., network 490), such as one or more external systems or between nodes of computer system 400. In various embodiments, network 490 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 440 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 450 may, in some embodiments, include one or more display terminals, keyboards, keypads, touch pads, scanning devices, voice or optical recognition devices, or any other devices suitable for entering or accessing data by one or more computer systems 400. Multiple input/output devices 450 may be present in computer system 400 or may be distributed on various nodes of computer system 400. In some embodiments, similar input/output devices may be separate from computer system 400 and may interact with one or more nodes of computer system 400 through a wired or wireless connection, such as over network interface 440.

In some embodiments, the illustrated computer system may implement any of the methods described above, such as the method illustrated by the flowchart of FIG. 3. In other embodiments, different elements and data may be included.

Those skilled in the art will appreciate that computer system 400 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, etc. Computer system 400 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 400 may be transmitted to computer system 400 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, etc.), ROM, etc.

The methods described herein may be implemented in software, hardware, or a combination thereof, in different embodiments. In addition, the order of methods may be changed, and various elements may be added, reordered, combined, omitted, modified, etc. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. In addition, structures and functionality presented as discrete components in the example configurations may be implemented as a combined structure or component. These and other variations, modifications, additions, and improvements may fall within the scope of embodiments as defined in the claims that follow.

In the foregoing description, numerous specific details, examples, and scenarios are set forth in order to provide a more thorough understanding of the present principles. It will be appreciated, however, that embodiments of the principles can be practiced without such specific details. Further, such examples and scenarios are provided for illustration, and are not intended to limit the teachings in any way. Those of ordinary skill in the art, with the included descriptions, should be able to implement appropriate functionality without undue experimentation. References in the specification to “an embodiment,” etc., indicate that the embodiment described may include a particular feature, structure, or characteristic, but every embodiment may not necessarily include the particular feature, structure, or characteristic. Such phrases are not necessarily referring to the same embodiment. Further, when a particular feature, structure, or characteristic is described in connection with an embodiment, it is believed to be within the knowledge of one skilled in the art to effect such feature, structure, or characteristic in connection with other embodiments whether or not explicitly indicated. Embodiments in accordance with the teachings can be implemented in hardware, firmware, software, or any combination thereof. Embodiments may also be implemented as instructions stored using one or more machine-readable media, which may be read and executed by one or more processors.

A machine-readable medium may include any mechanism for storing or transmitting information in a form readable by a machine (e.g., a computing device or a “virtual machine” running on one or more computing devices). For example, a machine-readable medium may include any suitable form of volatile or non-volatile memory. Modules, data structures, blocks, and the like are referred to as such for case of discussion and are not intended to imply that any specific implementation details are required. For example, any of the described modules and/or data structures may be combined or divided into sub-modules, sub-processes or other units of computer code or data as may be required by a particular design or implementation. Further, references herein to rules or templates are not meant to imply any specific implementation details. That is, the radio signal access system of the present principles can store rules, templates, etc. in any suitable machine-readable format.

Schematic elements used to represent instruction blocks or modules may be implemented using any suitable form of machine-readable instruction, and each such instruction may be implemented using any suitable programming language, library, application-programming interface (API), and/or other software development tools or frameworks. Similarly, schematic elements used to represent data or information may be implemented using any suitable electronic arrangement or data structure. Further, some connections, relationships or associations between elements may be simplified or not shown in the drawings so as not to obscure the teachings herein. While the foregoing is directed to embodiments of the present invention, other and further embodiments of the invention may be devised without departing from the basic scope thereof, and the scope thereof is determined by the claims that follow.

1. A method for multiband radio signal processing for providing radio signals to a network connected device, comprising:
receiving multiband radio signals;
tuning the multiband radio signal to a radio frequency band based on a received request from a network-connected device for the radio frequency band; and
communicating data associated with the requested radio frequency band to the requesting network-connected device over the network using an application programming interface.

2. The method of claim 1, further comprising;
converting the requested radio frequency band to a digital data signal before communicating the data associated with the selected radio frequency band to the requesting network-connected device.

3. The method of claim 1, further comprising:
monitoring the requested radio frequency band to identify sound recordings in the requested radio frequency band for which royalties need to be collected and distributed.

4. The method of claim 1, further comprising:
providing a web application for enabling communication with the application programming interface.

5. The method of claim 1, further comprising:
presenting data associated with the requested radio frequency band on the requesting network-connected device using an application installed on the network-connected device.

6. The method of claim 1, wherein the requested radio frequency band comprises radio frequency signals from the group consisting at least one of VLF, LF, MF HF, VHF, UHF, SHF or EH.

7. The method of claim 1, wherein the requested radio frequency band comprises radio frequency signals including at least one of AM/FM radio frequencies or radio frequencies used by satellites to communicate data.

8. The method of claim 1, wherein the network-connected device comprises an internet-connected device.

9. An apparatus for multiband radio signal processing for providing radio signals to a network connected device, comprising:
at least one processor and at least one memory for storing programs and instructions that, when executed by the at least one processor, causes the apparatus to perform operations comprising:
receiving multiband radio signals;
tuning the multiband radio signal to a radio frequency band based on a received request from a network-connected device for the radio frequency band; and
communicating data associated with the requested radio frequency band to the requesting network-connected device over the network using an application programming interface.

10. The apparatus of claim 9, wherein the apparatus further performs;
converting the requested radio frequency band to a digital data signal before communicating the data associated with the selected radio frequency band to the requesting network-connected device.

11. The apparatus of claim 9, wherein the apparatus further performs:
providing a web application for enabling communication with the application programming interface.

12. The apparatus of claim 9, wherein the apparatus further performs:
presenting data associated with the requested radio frequency band on the requesting network-connected device using an application installed on the network-connected device.

13. The apparatus of claim 9, wherein the requested radio frequency band comprises radio frequency signals from the group consisting at least one of VLF, LF, MF HF, VHF, UHF, SHF or EH.

14. The apparatus of claim 9, wherein the requested radio frequency band comprises radio frequency signals including at least one of AM/FM radio frequencies or radio frequencies used by satellites to communicate data.

15. The apparatus of claim 9, wherein the network-connected device comprises an internet-connected device.

16. A system for multiband radio signal processing for providing radio signals to a network connected device, comprising:
an antenna configured to receive radio signals;
a tuning chip configured to tune radio signals;
a software defined radio module configured to convert radio signals to a discrete digital radio signals;
an application program interface module configured to communicate with a software application of a remote network-connected device; and
an apparatus including at least one processor and at least one memory for storing programs and instructions that, when executed by the at least one processor, causes the system to perform operations comprising:
receiving multiband radio signals at the antenna;
using the tuning chip, tuning the multiband radio signal to a radio frequency band based on a received request from a user using the software application of the network-connected device; and
communicating data associated with the requested radio frequency band to the requesting network-connected device over the network using the application programming interface module.

17. The system of claim 16, wherein the system further performs;
converting the requested radio frequency band to a digital data signal before communicating the data associated with the selected radio frequency band to the requesting network-connected device.

18. The system of claim 16, wherein the system further performs:
providing a web application for enabling communication with the application programming interface.

19. The system of claim 16, wherein the apparatus further performs:
presenting data associated with the requested radio frequency band on the requesting network-connected device using an application installed on the network-connected device.

20. The system of claim 16, wherein the network-connected device comprises an internet-connected device.
